(19) United States
(12) Patent Application Publication
(10) Pub. No.: US 2015/0016157 A1
(43) Pub. Date: Jan. 15, 2015

(54) Constant switching frequency discontinuous current mode average output current control scheme

(71) Applicants: Qi Cui Wei, Hangzhou (CN); Da Feng Weng, Sunnyvale, CA (US)

(72) Inventors: Qi Cui Wei, Hangzhou (CN); Da Feng Weng, Sunnyvale, CA (US)

(21) Appl. No.: 13/987,172

(22) Filed: Jul. 9, 2013

(51) Int. Cl. H02H 7/12

(52) U.S. Cl. CPC H02H 7/1203
USPC 363/50

(57) ABSTRACT

The constant switching frequency discontinuous current mode average output current control scheme is composed of a reference block, reference calculation block, state detecting block, error detector block, zero state detector, power driver block and internal clock. The reference block generates preset reference; The reference calculation block, based on the power current converter's power topology, the correspondent algorithm is calculated to convert the input reference from the reference block into correspondent output; It is the output of reference calculation block that makes state detecting block, error detector block, zero state detector, power driver block and internal clock operate together and control the power current converter's output following with the output of reference block

### BACKGROUND OF THE INVENTION

The present invention relates to power converter topology structure and control. More particularly, the invention relates to a control scheme for power current converter's average output current, that is, a constant switching frequency discontinuous current mode average output current control scheme.

In existing power current converter control schemes, as power current converter's inductor current running in discontinuous mode (DCM), there is constant power control scheme. That is, as the peak current of the inductor can be controlled, the output power can be controlled.

$${P}_{OUT} = \frac{1}{2} \cdot {f}_{S} \cdot L \cdot {I}_{peak}^{2}$$

It is used to generate a series of PWM pulses and to control the power switch in the power current converter. It can make the output average current following the preset reference signal. The control scheme makes that the average output accuracy largely dependent on the input and output voltages of the power current converter, accuracy of circuit devices and switching frequency. In lower accuracy output applications, the control scheme has been widely used. To increase control accuracy is a key point to extend the control scheme application area.

### SUMMARY OF THE INVENTION

The present invention discloses a novel “constant switching frequency discontinuous current mode average output current control” scheme to control a switching converter and make the average output current accuracy independent of multiple factors: the input and output voltages of the switching converter and accuracy of circuit devices and related switching frequency.

The constant switching frequency discontinuous current mode average output current control scheme is composed of a reference block, reference calculation block, state detecting block, error detector block, zero state detector, power driver block and internal clock. The reference block generates preset reference; The reference calculation block, based on the power current converter's power topology, the correspondent algorithm is calculated to convert the input reference from the reference block into correspondent output; The state detecting block is designed to detect states of power current converter and the detected signals are converted into the same signal format as one of output from the reference calculation block; The error detector is used to detect the error between the outputs from the reference calculation block and the state detected block and to trigger the power driver block to turn off the power switch in the power current converter as the error is cross over zero; The zero state detector is used to detect when the states of the power current converter is cross over zero to feedback the signal into the reference calculation block; The internal clock triggers power driver block to turn on the power switch in the power current converter; The power driver block is controlled with both the error detector and the internal clock to drive the power switch in the power current converter; Reference block, reference calculation block, error detector block, power driver block are connected in sequence; The output of zero state detector is one input of the reference calculation block; The output of the error detector block is one input of the reference calculation block through the output of the power driver; The output of state detecting block is one input of the error detector block; The output of internal clock is one input of the power driver block.

The reference block can be simple as comprising of a basic operation and be implemented with several operation functions. Based on the power current converter's topology, the reference calculation block's correspondent algorithm is calculated to convert the input reference signal from the reference block into the correspondent power current converter's reference control signal. It can be one simple fixed gain operation and be implemented with several operation functions. In the reference calculation block, based on the implemented correspondent algorithm scheme, the input and output voltages of the power current converter will not involve the correspondent algorithm calculation to generate correspondent reference control signal. The error detector block can be simple as basic comparison operation and be implemented with several operation functions. The state detect block can be simple as a sense resistor and be implemented with several operation functions. The zero state detect block can be simple as comprising of a basic comparator operation and be implemented with several operation functions. The power driver block can be simple as comprising of a basic driving operation and be implemented with several operation functions.

Based on the power current converter's power topology, the correspondent algorithm is calculated to convert the preset reference signal from the reference block into the correspondent power current converter's reference control signal. In order to compare the reference control signal and the state variables of the power current converter during the power switch turn-on, the output V_{iL} from state detecting block and the output V_{REF}_{_{—}}_{C} from the reference calculation block are detected in the error detector block. As the output from error detector is a cross over zero, the output of the error detecting block controls the power driver to turn off the power switch of the power current converter and send the signal into the reference calculation block through the output of the power driver. The zero state detecting block keeps to detect state variables of the power current converter. As the state variable crosses zero, the zero state detecting block sends the signal into the reference calculation block. The internal clock triggers the power driver to turn on the power switch of the power current converter and repeat switching cycle.

With the present invention, the inductor current is a switching cycle discontinuous triangle waveform. The valley of the inductor current is zero and the inductor average current is less than half of the peak inductor current.

The peak inductor current is followed with the reference control signal V_{REF}_{_{—}}_{C} from the reference calculation block related with preset reference signal V_{REF} of power current converter and the output average current of the power current converter will follow with the preset reference signal V_{REF}.

The present invention control scheme is simple and does not require any additional compensation circuit. With the control scheme, the output average current of the power current converter is independent of input and output voltages of the switching converter and accuracy of circuit devices and related switching frequency.

### BRIEF DESCRIPTION OF THE DRAWINGS

FIG. 1 is the present invention “constant switching frequency discontinuous current mode average output current control” scheme block diagram for power current converter;

FIG. 2 is one detailed embodiment of the “constant switching frequency discontinuous current mode average output current control” scheme block diagram for flyback converter's average output current control;

FIG. 3 is one detailed embodiment of the “constant switching frequency discontinuous current mode average output current control” scheme block diagram for Buck-boost converter's average output current control;

FIG. 4 is one detailed embodiment of the “constant switching frequency discontinuous current mode average output current control” scheme block diagram for Boost converter's average output current control;

FIG. 5 is one detailed embodiment of the “constant switching frequency discontinuous current mode average output current control” scheme block diagram for Buck converter's average output current control;

### DETAILED DESCRIPTION OF THE INVENTION

FIG. 1 shows the invention scheme block diagram for power current converter. In the block diagram, there are reference block 1, reference calculation block 2, state detecting block 3, error detector block 4, zero state detector 5, power driver block 6 and internal clock. Reference block 1, reference calculation block 2, error detector block 4, power driver block 6 are connected in sequence; The output of zero state detector 5 is one input of reference calculation block; The output of state detecting block 3 is one input of error detector block; The output of internal clock is one input of power driver block 6. The output of power driver is one input of reference calculation block 2.

Based on the power current converter's power topology, the correspondent algorithm in reference calculation block 2 is calculated to convert the preset reference signal V_{REF} from the reference block 1 into correspondent power current converter's reference control signal V_{REF}_{_{—}}_{C}. In order to compare the reference control signal V_{REF}_{_{—}}_{C} and the state variables of the power current converter during the power switch turn-on, the output V_{iL} from state detecting block 3 and the output V_{REF}_{_{—}}_{C} from the reference calculation block are detected in the error detector block 4. As the output from error detector 4 is cross over zero, the output of the error detecting block 4 controls the power driver 6 to turn off the power switch of the power current converter and send the signal into the reference calculation block 2 through power driver output. The zero state detecting block 5 serves to detect state variables of the power current converter. As the state variable crosses over zero, the zero state detecting block 5 sends the signal into the reference calculation block 2. The internal clock triggers the power driver 6 to turn on the power switch of the power current converter and repeat switching cycle. The output of the power driver is one input of the reference calculation block.

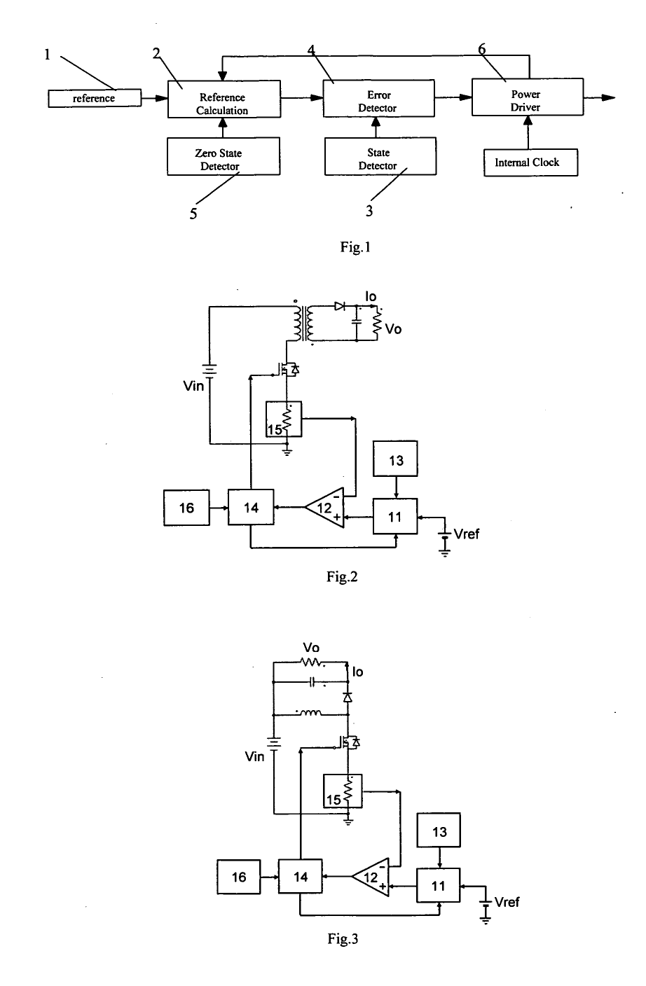

FIG. 2 shows one detailed embodiment of invention scheme block diagram for flyback power current converter. In the detailed block diagram, there are several blocks: preset reference signal V_{REF}, reference calculation block 11, comparator 12, zero state detector 13, power driver 14 for the power switch, state detector 15 and internal clock 16.

As the power switch turns on, the inductor current increases from zero. The inductor current is detected as a sense voltage on the sense resistor, state detector 15. In the comparator 12, the sensed voltage compares with the reference control signal V_{REF}_{_{—}}_{C} from the reference calculation block 11 correspondent with the preset reference signal V_{REF}. As the comparator 12 outputs from “1” to “0”, the power driver 14 turns off the power switch and the output of comparator feedback to the reference calculation block 11 through power driver 14 output. The zero state detector 13 detects the inductor current of the flyback power current converter. As the inductor current decays and crosses over zero, the zero state detector 13 feedbacks the signal to the reference calculation block 11. The internal clock 16 triggers the power driver 14 to turn on the power switch. In this way, the power switch turns on and off during the switching cycle.

The reference calculation block 11 of the flyback power current converter shown in FIG. 2 is based on the flyback power current converter topology. Due to feedback from the zero state detector 13 and the power driver 14, input and output voltages of the flyback power current converter will not involve the correspondent algorithm calculation to generate a corresponding reference control signal. The peak inductor current of the flyback power current converter follows the reference control signal V_{REF}_{_{—}}_{C} output from the reference calculation block 11 and it makes the average output current of the flyback power current converter follow with the preset reference signal V_{REF}. With the control scheme, the output average current of the flyback power current converter is independent of input and output voltages of the switching converter and accuracy of circuit devices and related switching frequency.

FIG. 3 shows the second detailed embodiment of invention scheme block diagram for Buck-Boost power current converter. In the detailed block diagram, there are several blocks: preset reference signal V_{REF}, reference calculation block 11, comparator 12, state zero detector 13, power driver 14 for the power switch, sense resistor (state detector 15) and internal clock 16. The operation principle is the same as the flyback power current converter shown in FIG. 2.

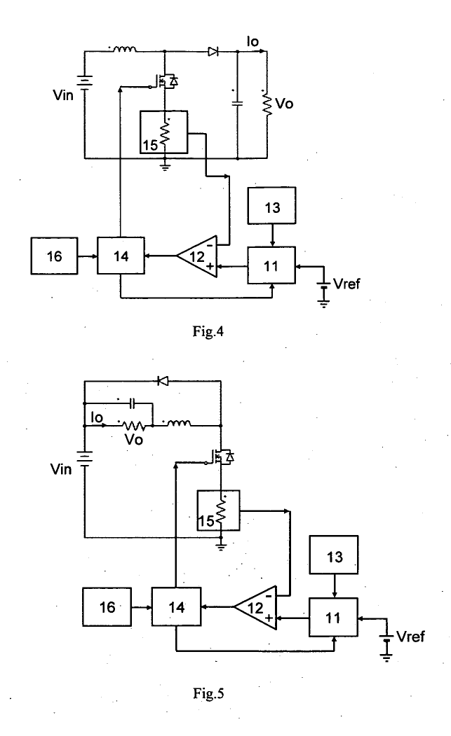

FIG. 4 shows the third detailed embodiment of invention scheme block diagram for Boost power current converter. In the detailed block diagram, there are several blocks: preset reference signal V_{REF}, reference calculation block 11, comparator 12, state zero detector 13, power driver 14 for the power switch, sense resistor (state detector 15) and internal clock 16. The operation principle is the same as that of the flyback power current converter shown in FIG. 2.

FIG. 5 shows the fourth detailed embodiment of invention scheme block diagram for Buck power current converter. In the detailed block diagram, there are several blocks: preset reference signal V_{REF}, reference calculation block 11, comparator 12, state zero detector 13, power driver 14 for the power switch, sense resistor (state detector 15) and internal clock 16. The operation principle is the same as that of the flyback power current converter shown in FIG. 2.

As the inductor current in the power current converter is discontinuous, it means the current in the freewheeling diode of the power current converter can decay to zero. It can avoid the reverse recover current of the diode and reduce the switching loss of the power current converter. The core benefit of using “constant switching frequency discontinuous current mode average output current control” scheme is to make the average output current have high accuracy control and wide output range, with simple implementation and low cost. The power current converter's switching loss is lower. The whole system becomes much more efficient and cost effective.

What is claimed is:

1. A constant switching frequency discontinuous current mode average output current control scheme is composed of a reference block, a reference calculation block, a state detecting block, an error detector block, a zero state detector, a power driver block and an internal clock;
The reference block generates preset reference;
The reference calculation block, based on the power current converter's power topology, the correspondent algorithm is calculated to convert the input reference from the reference block into correspondent output;
The state detecting block is designed to detect states of power current converter and the detected signals are converted into the same signal format as one of output from the reference calculation block;
The error detector is used to detect the error between the outputs from the reference calculation block and the state detected block and to trigger the power driver block to turn off the power switch in the power current converter as the error is cross over zero;
The zero state detector is used to detect when the states of the power current converter is cross over zero to feedback the signal into the reference calculation block;
The internal clock triggers power driver block to turn on the power switch in the power current converter;
The power driver block is controlled with both the error detector and the internal clock to drive the power switch in the power current converter;
The reference block, the reference calculation block, the error detector block, the power driver block are connected in sequence;
The output of zero state detector is one input of the reference calculation block;
The output of the error detector block is one input of the reference calculation block through the output of the power driver;
The output of state detecting block is one input of the error detector block;
The output of internal clock is one input of the power driver block.

2. The constant switching frequency discontinuous current mode average output current control scheme claim 1, wherein, the reference block can be simple as comprising of a basic operation and be implemented with several operation functions.

3. The constant switching frequency discontinuous current mode average output current control scheme claim 1, wherein, based on the power current converter's topology, the reference calculation block's correspondent algorithm is calculated to convert the input reference signal from the reference block into the correspondent power current converter's reference control signal;
It can be one simple fixed gain operation and be implemented with several operation functions;
In the reference calculation block, based on the implemented correspondent algorithm scheme, the input and output voltages of the power current converter will not involve the correspondent algorithm calculation to generate correspondent reference control signal;

4. The constant switching frequency discontinuous current mode average output current control scheme claim 1, wherein, the error detector block can be simple as basic comparison operation and be implemented with several operation functions;

5. The constant switching frequency discontinuous current mode average output current control scheme claim 1, wherein, the state detect block can be simple as a sense resistor and be implemented with several operation functions.

6. The constant switching frequency discontinuous current mode average output current control scheme claim 1, wherein, the zero state detect block can be simple as comprising of a basic comparator operation and be implemented with several operation functions.

7. The constant switching frequency discontinuous current mode average output current control scheme claim 1, wherein, the power driver block can be simple as comprising of a basic driving operation and be implemented with several operation functions.
